(19) United States
(12) Patent Application Publication
(10) Pub. No.: US 2020/0025052 A1
(43) Pub. Date: Jan. 23, 2020

(54) HEATING MODULE

(71) Applicant: MAGNA STEYR Fuel Systems GesmbH, Sinabelkirchen (AT)

(72) Inventor: Joerg GROSS, Wesseling (DE)

(21) Appl. No.: 16/386,206

(22) Filed: Apr. 16, 2019

(30) Foreign Application Priority Data
Jul. 19, 2018 (EP) 18184490.3

(51) Int. Cl. F01N 3/28; F01N 3/20; F01N 9/00; H05B 3/06

(52) U.S. Cl. CPC F01N 3/2896; F01N 3/208; H05B 2203/021; H05B 3/06; F01N 9/00

(57) ABSTRACT

A heating module for heating a fluid in a tank of a motor vehicle, a heating module arrangement that includes at least two heating modules, and a tank device having a heating module arrangement. The heating module includes a heating element having a heating element carrier and at least one heating wire arranged on the heating element carrier, and a carrier module which surrounds and supports the heating element at both sides of the heating element carrier, the carrier module having an open support structure so that there is no material arranged between the at least one heating wire and an outer side of the heating module.

### CROSS-REFERENCE TO RELATED APPLICATIONS

The present application claims priority 35 U.S.C. § 119 to European Patent Publication Nos. EP 18184490.3 (filed on Jul. 19, 2018), which is hereby incorporated by reference in its complete entirety.

### TECHNICAL FIELD

Embodiments relate to a heating module for heating a fluid (e.g., urea solution) in a tank of a motor vehicle, a heating module arrangement comprising at least two such heating modules, and a tank device comprising at least one such heating module or one such heating module arrangement.

### BACKGROUND

SCR tank systems, in particular, urea tanks, store, as a result of increasingly high demands for exhaust gas post-processing in motor vehicles, increasingly high filling volumes since the consumption of liquid urea solution per kilometre driven increases. In order to ensure the supply of the exhaust gas post-processing, heating elements are increasingly installed in such tank systems. Previously, in relatively small containers, the heating elements were integrated in a conveying unit of the container. In the meantime, additional heating systems which may support such a heating element in a conveying unit were also installed in the containers. Such additional heating systems may be constructed as panel heating systems which may be secured in the tank wall or in formations on the tank wall. In order to protect heating wires which are used in such panel heating systems, the heating elements are encapsulated in plastics material, in particular injection-moulded. As a result of the use of different tank shapes in different vehicles, such additional heating systems, that is to say, heating elements which may be secured to the container wall, must be formed in each case with a suitable member for the respective tank shape.

Such an encapsulated heating device is known, for example, from German Patent Publication No. DE 10 2015 003 098 A1.

### SUMMARY

In accordance with embodiments, a heating module and a heating module arrangement are provided for heating a fluid in a tank that facilitates efficient heating and adaptable in a simple manner to different tank geometries, and a tank device having such efficient heating by incorporating such a heating module and/or a heating module arrangement.

In accordance with embodiments, a heating module for heating a fluid such as urea solution in a tank, may comprise at least one of: a carrier module and a heating element having a film-like heating element carrier and at least one heating wire arranged on the heating element carrier, wherein the carrier module: (i) surrounds the heating element at both sides of the heating element carrier, and (ii) has an open support structure so that there is partially no material arranged between the heating wire and the outer side of the heating module.

In accordance with embodiments, a substantially plate-like or planar heating module for heating a fluid such as urea solution in a tank, may comprise at least one of: a flat, substantially film-like heating element carrier, for example, a flexible carrier mesh; at least one heating wire or a plurality of heating wires for resistance heating of the fluid being arranged on the heating element carrier; and a carrier module which surrounds the heating element(s) to thereby carry and support the heating elements.

In accordance with embodiments, each carrier module has an open structure so that, although the film-like heating element carriers are adequately supported, the heating wire(s) nonetheless at least partially has free access to the outer side thereof. A significantly enhanced heat transfer to the fluid may thereby be achieved and consequently heating may be carried out in a particularly efficient manner. The heating modules, therefore, do not use injection-moulding or other embedding in a plastics material or similar material at all, as conventional in previous comparable heating systems.

In accordance with embodiments, as a result of the open construction of the support structure for the carrier module, without encapsulations of the heating element carrier and the heating element, this may be more simply placed in a carrier module and replaced. The carrier module and heating element may be produced separately, and at a later time in the production process, depending on requirements, may be equipped in particular for different tank shapes and sizes, including, for example, a plurality of carrier modules with common or individual heating elements, and for which are to be installed in a tank.

In accordance with embodiments, the carrier module is constructed to be able to be readily opened so that a heating element may be placed in the carrier module or removed from the carrier module.

In accordance with embodiments, the carrier module may have a hinge (e.g., a film hinge) at a first end thereof for facilitating the folding of the carrier module between an open position and a closed position. In such an embodiment, the carrier module may then comprise two carrier module halves which are to be connected via the hinge.

In accordance with embodiments, the open support structure of the carrier module has an auxiliary positioning member (e.g., positioning domes) to correct the positioning of the heating element in the carrier module, in particular. Each positioning dome may be constructed in such a manner that not only is the heating element secured in the position thereof as a result, but also the carrier module halves of the carrier module are thereby fixed to each other via a clip-fit connection.

In accordance with embodiments, the carrier module has at least one clip-fitting member, for example, a groove-like receiving recess which is constructed to clip-fit the carrier module to a corresponding clip-fitting counter-member of the tank device, for example, a clement which engages round at two sides. The clip-fitting member may be formed, for example, at the second end of the carrier module which is opposite the first end having the hinge.

In accordance with embodiments, a heating module arrangement may comprise: at least two heating modules as described hereinabove, wherein the two carrier modules of the heating modules are connected to each other via a flexible articulation. In this instance, the flexible articulation may be constructed integrally with one or both carrier module(s) or may be formed by a separate component which, in particular, may be inserted into the two carrier modules. If the articulation is constructed integrally on a carrier module, the second side of the articulation may be inserted into the second carrier module. The articulation may, for example, extend substantially over the entire height of the heating modules, normally on a tank wall for securing the modules. The articulation may, therefore, be arranged at a third end of the carrier module which extends laterally on the carrier module between the first end and the second end.

In accordance with embodiments, a tank device may comprise a tank member (e.g., a urea tank); and at least one heating module or a heating module arrangement as described hereinabove. In this instance, the tank member may have a clip-fitting counter-member and the heating module or the heating module arrangement may be clip-fitted in the installation position vertically or horizontally in the clip-fitting counter-member of the tank member.

### DRAWINGS

Embodiments will be illustrated by way of example in the drawings and explained in the description below.

FIG. 1 illustrates a heating element of a heating module, in accordance with embodiments.

FIG. 2 illustrates a carrier module of a heating module, in accordance with embodiments.

FIG. 3 illustrates a heating module arrangement having three heating modules, in accordance with embodiments.

FIG. 4 illustrates a top view of the heating module arrangement of FIG. 3.

FIG. 5 illustrates the heating module arrangement of FIG. 3, but with a portion of a tank member during the production of a tank device, in accordance with embodiments.

### DESCRIPTION

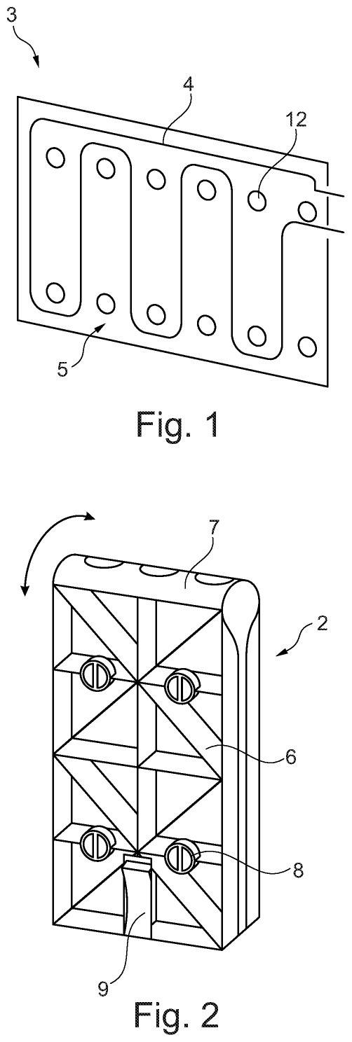

As illustrated in FIG. 1, a heating element 3 of a heating module in accordance with embodiments is provided. The heating module has at least one heating wire 4 arranged on a film-like heating element carrier 5. The heating element carrier 5 may be formed of a flexible carrier mesh. The heating wire 4 may, for example, extend in a meandering manner on the surface of the heating element carrier 5 and guided laterally out of the heating element carrier 5 for connection to a voltage source. The heating wire 4 may be an insulated wire. The heating element carrier 5 additionally has a plurality of positioning openings 12 in the form of a plurality of round apertures. The positioning openings 12 serve to position the heating element carrier 5 in a carrier module 2.

As illustrated in FIG. 2, a carrier module 2 of a heating module in accordance with embodiments is provided. The carrier module 2 is constructed to surround the heating element 3 at both sides of the film-like heating element carrier 5. The carrier module 2 is constructed in the form of a foldable frame having two side portions which each form an open support structure 6. The structure is open insofar as there is partially no material arranged between the heating wire 4 and the outer side of the heating module. This includes the possibility that the heating wire 4 itself has a conventional wire insulation. The support structure 6 is formed in the manner of a lattice structure via struts. Because there are openings between the struts, the heating element 3 is freely accessible.

The carrier module 2 has a hinge 7 at a first end thereof to facilitate movement or folding of the carrier module 2 between an open position and a closed position (as indicated by a double-headed arrow in FIG. 2). With the carrier module 2 folded in an open position, a heating element 3 may be placed in the carrier module 2 or removed from the carrier module 2.

The open support structure 6 of the carrier module 2 also includes one or more auxiliary positioning members 8 in the form of positioning domes, to facilitate the correct positioning of the heating element 3 in the carrier module 2. The positioning openings 12 of a heating element 3 may, in a correct position, be arranged around the positioning domes 8.

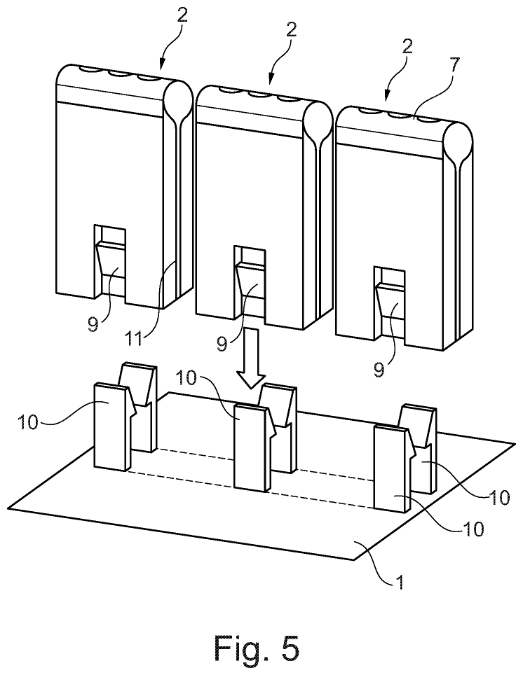

The carrier module 2 has a clip-fitting member 9, for example, a receiving recess which is configured to clip-fit the carrier module 2 to a corresponding clip-fitting counter-member 10 of a tank member 1 (See, FIG. 5). The clip-fitting member 9 may comprise a catch hook. The clip-fitting member 9 is constructed at the second end (e.g., at the bottom of FIG. 2) of the carrier module 2, which is opposite the first end having the hinge 7.

As illustrated in FIG. 5, a plurality of carrier modules 2 or a plurality of heating modules may be secured via their clip-fitting geometries 9 to a wall of a tank module 1 of a tank device. The heating modules may be connected or not connected to each other.

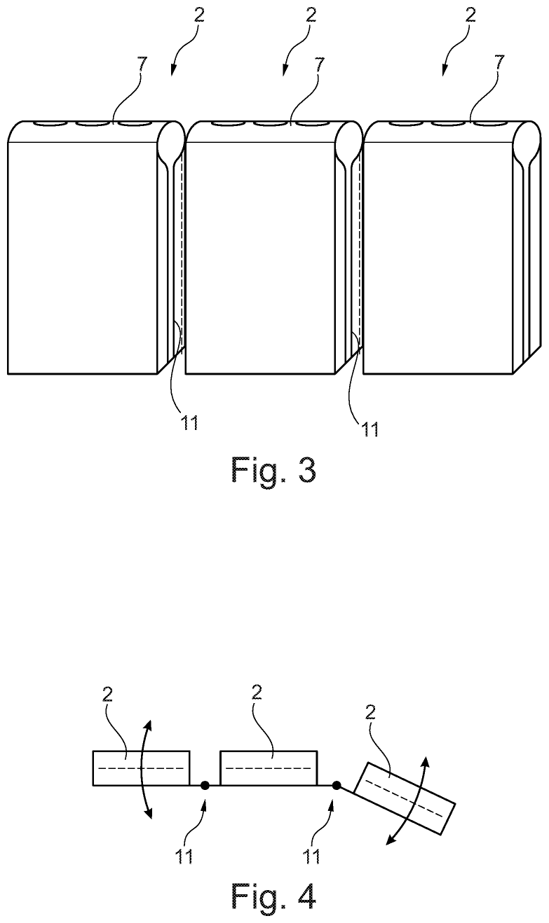

As illustrated in FIG. 3, a heating module arrangement may include a plurality of carrier modules 2 that are connected to each other in each case via a flexible articulation member 11. The flexible articulation member 11 may be formed integrally with one or each carrier module(s) 2, in particular, produced together with the carrier component(s) in a common injection-moulding operation. The articulation member 11 may also be a separate component, in particular, a plug-type component. The articulation member 11 is arranged at a third end of the carrier module 2 which extends at a lateral side of the carrier module 2 between the first end and the second end. The articulation member 11 may extend, for example, over a large portion of a side face or sidewall of the folding frame of the carrier module 2.

As illustrated in FIG. 5, production of a tank device in accordance with embodiments includes the heating module arrangement of FIG. 3 in which the carrier modules 2 are connected to a portion of a tank member 1. In an example, each carrier module 2 is individually connected by insertion to a tank wall of the tank member 1. The tank wall of the tank member 1 has a plurality of clip-fitting counter-geometries 10 into which the clip-fitting geometries 9 of each carrier module 2 may be inserted and clip-fitted. The clip-fitting counter-geometries 10 may be constructed as projections with catch hooks. The path of the clip-fitting counter-geometries 10 may, in this embodiment, determine the arrangement of the heating modules in the tank. The heating modules may, in particular, be installed vertically or horizontally in the tank 1.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Tank
2 Carrier module
3 Heating element
4 Heating wire
5 Heating element carrier
6 Open support structure
7 Hinge
8 Auxiliary positioning member
9 Clip-fitting member
10 Clip-fitting counter-member
11 Articulation member
12 Positioning openings

What is claimed is:

1. A heating module for heating a fluid in a tank of a motor vehicle, the heating module comprising:
a heating element having a heating element carrier and at least one heating wire arranged on the heating element carrier; and
a carrier module which surrounds and supports the heating element at both sides of the heating element carrier, the carrier module having an open support structure so that there is no material arranged between the at least one heating wire and an outer side of the heating module.

2. The heating module of claim 1, wherein the carrier module moveable to an open position to facilitate receipt of the heating element therein and removal of heating element therefrom.

3. The heating module of claim 1, wherein the carrier module comprises a hinge, arranged at a first end thereof, to facilitate movement of the carrier module between an open position and a closed position.

4. The heating module of claim 1, wherein the carrier module comprises an auxiliary positioning member at the open support structure to facilitate correct positioning of the heating element in the carrier module.

5. The heating module of claim 1, wherein the carrier module comprises at least one clip-fitting member to facilitate connection of the carrier module to the tank.

6. The heating module of claim 1, wherein the carrier module comprises:
a hinge, arranged at a first end thereof, to facilitate movement of the carrier module between an open position and a closed position; and
at least one clip-fitting member, arranged at a second end thereof which is opposite the first end, to facilitate connection of the carrier module to the tank.

7. A heating module arrangement for heating a fluid in a tank of a motor vehicle, the heating module arrangement comprising:
heating modules, each heating module including:
a heating element having a heating element carrier and at least one heating wire arranged on the heating element carrier, and
a carrier module which surrounds and supports the heating element at both sides of the heating element carrier, the carrier module having an open support structure so that there is no material arranged between the at least one heating wire and an outer side of the heating module, and a articulation member, composed of a flexible material, to connect adjacent heating modules to each other.

8. The heating module arrangement of claim 7, wherein the articulation member is constructed integrally with each carrier module.

9. The heating module arrangement of claim 7, wherein the articulation member is constructed as a separate component which is received by a corresponding carrier module.

10. The heating module arrangement of claim 7, wherein each carrier module comprises:
a hinge, arranged at a first end thereof, to facilitate movement of the carrier module between an open position and a closed position; and
at least one clip-fitting member, arranged at a second end thereof which is opposite the first end, to facilitate connection of the carrier module to the tank.

11. The heating module arrangement of claim 10, wherein the articulation member is arranged at a third end of the carrier module which extends on the carrier module between the first end and the second end.

12. The heating module arrangement of claim 7, wherein each carrier module comprises an auxiliary positioning member at the open support structure to facilitate correct positioning of the heating element in the carrier module.

13. A tank device for a motor vehicle, the tank device comprising:
a tank member to receive a fluid; and
at least one heating module arrangement that includes heating modules that are supported by the tank member in an installation position, each heating module including:
a heating element having a heating element carrier and at least one heating wire arranged on the heating element carrier, and
a carrier module which surrounds and supports the heating element at both sides of the heating element carrier, the carrier module having an open support structure so that there is no material arranged between the at least one heating wire and an outer side of the heating module, and a articulation member, composed of a flexible material, to connect adjacent heating modules to each other.

14. The tank device of claim 13, wherein each carrier module comprises at least one clip-fitting member which is to clip-fit the carrier module to a corresponding clip-fitting counter-member of the tank member to thereby support the heating modules on the tank member in a vertically-oriented installation position.

15. The tank device of claim 13, wherein each carrier module comprises at least one clip-fitting member which is to clip-fit the carrier module to a corresponding clip-fitting counter-member of the tank member to thereby support the heating modules on the tank member in a horizontal-oriented installation position.

16. The tank device of claim 13, wherein the articulation member is constructed integrally with each carrier module.

17. The tank device of claim 13, wherein the articulation member is constructed as a separate component which is received by a corresponding carrier module.

18. The tank device of claim 13, wherein each carrier module comprises:
a hinge, arranged at a first end thereof, to facilitate movement of the carrier module between an open position and a closed position; and
at least one clip-fitting member, arranged at a second end thereof which is opposite the first end, to facilitate connection of the carrier module to the tank.

19. The tank device of claim 18, wherein the articulation member is arranged at a third end of the carrier module which extends on the carrier module between the first end and the second end.

20. The tank device of claim 13, wherein each carrier module comprises an auxiliary positioning member at the open support structure to facilitate correct positioning of the heating element in the carrier module.
